(19) United States
(12) Patent Application Publication
(10) Pub. No.: US 2023/0249131 A1
(43) Pub. Date: Aug. 10, 2023

(54) METHOD FOR REDUCING NITROGEN DIOXIDE IN EXHAUST GAS OF STATIONARY SOURCE WITHOUT INJECTION OF REDUCING AGENT

(71) Applicants: SK GAS CO., LTD., Seongnam-si (KR); ENEK CO., LTD., Seosan-si (KR)

(72) Inventors: Jung Ho Kim, Yongin-Si (KR); Min Kee Jeon, Seoul (KR); Ung Gi Hong, Seongnam-si (KR); Deuk Soo Park, Yongin-si (KR); Mi Young Lee, Seongnam-si (KR)

(21) Appl. No.: 18/015,133

(22) PCT Filed: Jun. 3, 2021
(86) PCT No.: PCT/KR2021/006919

§ 371 Date: Jan. 9, 2023

(30) Foreign Application Priority Data
Jul. 21, 2020 (KR) 10-2020-0090484

(51) Int. Cl. B01D 53/94

(52) U.S. Cl. CPC B01D 53/9418; B01D 2255/207; B01D 2257/404

(57) ABSTRACT

Provided through the present disclosure is a method for reducing nitrogen dioxide in exhaust gas of a stationary source by using selective catalytic reduction (SCR) without injection of a reducing agent, the method comprising the steps of: (a) providing exhaust gas generated in the stationary source wherein the exhaust gas includes at least one of CO, H₂, and hydrocarbon; (b) contacting the exhaust gas with a catalyst to reduce nitrogen dioxide in the exhaust gas; and (c) discharging into air the exhaust gas that has undergone step (b).

### CROSS-REFERENCE TO RELATED APPLICATION

This application is a 371 of PCT application No. PCT/KR2021/006919, FILED ON Jun. 3, 2021, the disclosure of which is herein incorporated by reference in its entirety.

### TECHNICAL FIELD

The present disclosure relates to a method of reducing nitrogen dioxide in exhaust gas generated from a stationary emission source. More particularly, the present disclosure relates to a method of reducing nitrogen dioxide in exhaust gas generated from a stationary emission source without injecting an additional reductant while using a selective catalytic reduction (SCR) process.

### BACKGROUND ART

Nitrogen oxides (NO_{X}), which refer to nitric oxide, nitrogen dioxide, nitrous oxide, and so on, generally contained in exhaust gas are one of representative materials causing environmental pollution. Recently, by changing process conditions and so on to satisfy strict environmental standards, exhaust gases in which a content of nitrogen oxides is adjusted to satisfy an allowable exhaust standard are discharged into the atmosphere. However, even if the content of nitrogen oxides in the exhaust gas satisfies the allowable exhaust standard, there is a problem in that a yellow plume phenomenon may occur when nitrogen dioxide in the exhaust gas exceeds about 15 ppm. Since this yellow plume has a problem in that it causes serious visible pollution and thus psychologically affects nearby people, it is necessary to prevent such a yellow plume. In order to prevent a generation of a yellow plume, a technology capable of reducing nitrogen dioxide in exhaust gas is required.

In existing facilities developed for the reduction of nitrogen dioxide, the injection of a reductant has been necessarily required so as to reduce nitrogen dioxide. However, since a substantial amount of reductant is required to be injected during each time reducing nitrogen dioxide, there is a problem of an occurrence of continuous operating costs. In addition, facilities for injecting a reductant are necessarily required to be considered in advance at the time of designing a factory, so that there is a problem of an occurrence of installation costs in accordance with this consideration.

In the SCR process for reducing nitrogen dioxide, ammonia or urea is commonly injected as a reductant. However, the use of these reductants has a problem in that such as unreacted ammonia and a byproduct of an ammonia slip phenomenon are generated. The ammonia is treated as one of the main causes of fine dust, and the amount of emission of the ammonia is strictly limited recently in view of environmental regulations.

Meanwhile, an HC-SCR is known as a technology that is capable of reducing NO_{X} by using a hydrocarbon as a reductant, and has been utilized to reduce NO_{X} from a mobile emission source. However, for a stationary emission source such as a factory, a power plant, and so on, exhaust gas discharged from the stationary emission source has higher content of O₂ comparing to exhaust gas discharged from the mobile emission source such as a vehicle and so on, so that nitric oxide (NO) is more easily to be oxidized, thereby having a poor efficiency in reducing NO_{X}. In addition, unlike the exhaust gas discharged from the mobile emission source, there is very little or no content of hydrocarbon (HC), in which the HC is used as a reductant of the HC-SCR, in the exhaust gas discharged from the stationary emission source, so that there is a problem in that it is required to supply a separate HC for reducing NO_{X} to a desired level. In addition, in reducing NO_{X}, the efficiency of the HC-SCR has not yet surpassed the efficiency of an NH₃-SCR. In addition, the application of the HC-SCR to reduce the NO_{X} at the stationary emission source has not been actively applied until now. Furthermore, a technology for reducing a yellow plume, that is, a technology applying the HC-SCR at the stationary emission source to reduce a yellow plume which is caused by nitrogen dioxide has not been known until now.

### DOCUMENT OF RELATED ART

### Patent Document

(Patent Document 1) KR0136893 B1

(Patent Document 2) JP2008-238069 A

### DISCLOSURE

### Technical Problem

The inventors of the present disclosure have found an advantage of using a hydrocarbon as a reductant in reducing nitrogen dioxide from a stationary emission source, and have arrived at the present disclosure. Therefore, an aspect of the present disclosure is to provide a method of reducing nitrogen dioxide in exhaust gas generated from a stationary emission source without injecting a separate reductant while using a selective catalytic reduction (SCR) process.

### Technical Solution

In order to achieve the objectives of the present disclosure, there is provided a method of reducing nitrogen dioxide in exhaust gas without injecting a reductant while using a selective catalytic reduction (SCR) process, the method including: (a) providing exhaust gas generated from a stationary emission source, wherein the exhaust gas includes at least one of CO, H₂, and a hydrocarbon; (b) reducing nitrogen dioxide in the exhaust gas by contacting the exhaust gas with a catalyst; and (c) discharging the exhaust gas having passed through the reducing the nitrogen dioxide in the exhaust gas to the atmosphere.

According to an embodiment of the present disclosure, a NO₂/NO_{X} ratio in the exhaust gas may be equal to or more than 0.3.

According to an embodiment of the present disclosure, the hydrocarbon may include i-paraffins, n-paraffins, aromatic hydrocarbons, olefins, or alcohols.

According to an embodiment of the present disclosure, when CO, H₂, or a hydrocarbon is present in the exhaust gas, the CO may have a content of 50 ppm or more, the H₂ may have a content of 500 ppm or more, or the hydrocarbon may have a content of 30 ppm or more.

According to an embodiment of the present disclosure, the (b) may be performed in a reactor, wherein the catalyst may be fixed in the reactor, and wherein the reducing the nitrogen dioxide in the exhaust gas may further include (d) supplying the exhaust gas in the reactor, wherein a temperature range of the exhaust gas may be 300° C. to 500° C., and the exhaust gas may be supplied to the reactor at a space velocity of 20,000 h⁻¹ to 40,000 h⁻¹.

According to an embodiment of the present disclosure, the catalyst may include a transition metal.

According to an embodiment of the present disclosure, a content of nitrogen dioxide in the exhaust gas discharged at the discharging the exhaust gas may be 12 ppm or less.

### Advantageous Effects

By using the method of reducing nitrogen dioxide of the present disclosure, it is possible to efficiently remove nitrogen dioxide in exhaust gas generated from a stationary emission source. Accordingly, it is possible to prevent a generation of a yellow plume by reducing the content of nitrogen dioxide in exhaust gas to less than 15 ppm.

In addition, since the method of reducing nitrogen dioxide of the present disclosure does not use ammonia as a reductant, there is no problem caused by the use of ammonia. Moreover, since the method of the present disclosure use a component that is present in exhaust gas, there is no need to inject a separate reductant to the exhaust gas, so that there has an economical advantage in view of a cost according to the injection of a reductant. In addition, since CO and a hydrocarbon that are volatile organic compounds (VOCs) which are harmful substances are used as a reductant, it possible to further reduce the content of VOCs that are discharged into the atmosphere, so that there is an advantage in view of eco-friendliness.

### DESCRIPTION OF DRAWINGS

FIG. 1 shows graphs illustrating comparative experimental results of conversion rates of nitrogen dioxide (NO₂) and nitrogen oxides (NO_{X}) according to an impregnation amount of silver (Ag) in a catalyst, performed in Lab test;

FIGS. 2-5 show graphs illustrating comparative experimental results of conversion rates of NO₂ and NO_{X} according to a type and a concentration of a reductant, performed in Lab test;

FIGS. 6 and 7 are graphs illustrating comparative experimental results of conversion rates of NO₂ and NO₂ according to a space velocity of exhaust gas, performed in Lab test;

FIG. 8 shows graphs illustrating comparative experimental results of conversion rates of NO₂ and NO₂ according to a difference in a concentration of NO₂/NO_{X} in exhaust gas, performed in Lab test;

FIG. 9 shows graphs illustrating a tendency of exhaust gas in a front stage of a reactor, performed in Pilot test;

FIG. 10 shows graphs illustrating a tendency of exhaust gas in a rear stage of a reactor performed in Pilot test;

FIG. 11 shows graphs illustrating reduction rates of nitrogen oxides according to a space velocity, performed in Pilot test;

FIG. 12 shows graphs illustrating reduction rates of nitrogen oxides according to a temperature, performed in Pilot test; and

FIG. 13 shows graphs illustrating a comparison of both Lab test results and Pilot test results.

### BEST MODE

The objectives, specific advantages, and novel features of the present disclosure will become more apparent from the following detailed description and preferred embodiments associated with the accompanying drawings, but the present disclosure is not necessarily limited thereto. Furthermore, in the description of the present disclosure, it is to be noted that, when known techniques related to the present disclosure may make the gist of the present disclosure unclear, a detailed description thereof will be omitted.

In the present disclosure, the terms “decrease”, “removal”, “conversion”, “reduction” of nitrogen dioxide mean a decrease of nitrogen dioxide content in exhaust gas, and are having the same meaning with each other. Therefore, the expressions may be used interchangeably in the present disclosure.

In the present disclosure, the term “NO_{X}” means total nitrogen oxides, and at least it should be noted that a reduction of NO_{X} and a reduction of NO₂ have distinctly different purposes in the present disclosure.

In the present disclosure, there is provided a method of reducing nitrogen dioxide in exhaust gas from a stationary emission source without injecting a reductant while using a selective catalytic reduction (SCR) process. In the present disclosure, the stationary emission source may include a power plant, a factory, and so on. More specifically, the stationary emission source in the present disclosure may be a factory performing a process in which a hydrocarbon compound may be a reactant and/or a product of the process. For example, the process may be a petrochemical process such as a dehydrogenation process of a lower hydrocarbon and an olefin production process. As described later, since the method of reducing nitrogen dioxide of the present disclosure is capable of using a hydrocarbon as a reductant, it may be more advantageous to apply the present disclosure to a process that is including a hydrocarbon compound as a reactant and/or a product of the process.

The method of the present disclosure does not use ammonia or urea as a reductant. According to the present disclosure, since a particular component or particular components in exhaust gas may function as a reductant, the method of the present disclosure does not necessarily require an injection of a separate reductant. Therefore, there is an advantage in that an injection means of a reductant does not need to be considered when a stationary emission source is initially designed. In addition, injecting substantial quantities of a reductant used for each time of reduction of nitrogen dioxide may be prevented, so that there is an advantage in that a cost problem occurring as a reductant is used does not need to be concealed.

The method of the present disclosure includes providing exhaust gas generated from a stationary emission source. The exhaust gas of the present disclosure is derived from a stationary to emission source, in which the exhaust gas is preferably derived from a stationary emission source that treats a hydrocarbon as a reactant and/or a product. Therefore, the exhaust gas differs in composition from exhaust gas derived from a mobile emission source such as a vehicle and so on. For example, a composition of exhaust gas derived from a mobile emission source (generated during diesel engine combustion) may be as follows: N₂ 67 mol %, CO₂ 12 mol %, H₂O 11 mol %, O₂ 9 mol %. On the other hand, a composition of exhaust gas derived from a stationary emission source such as a propane dehydrogenation (PDH) process may be as follows: N₂ 75 to 85 mol %, CO₂ 1.5 mol % or less, H₂O 5 to 10 mol %, O₂ 17 to 19 mol %. A main difference between the exhaust gas derived from the mobile emission source and the exhaust gas derived from the stationary emission source is a content of O₂. Since the exhaust gas derived from the stationary emission source has a relatively high content of O₂, nitric oxide (NO) in the exhaust gas is easily oxidized, so that there is a problem in that it is difficult to perform a NO_{X} removal that is a reduction reaction. In addition, comparing to a NO_{X} reduction in the exhaust gas derived from the mobile emission source, a NO_{X} reduction in the exhaust gas derived from the stationary emission source is performed under a very high processing flow rate, so that it is hard to expect to achieve a good reduction rate by a simple application of a NO_{X} reduction technology of a mobile emission source to a NO_{X} reduction technology of a stationary emission source.

Meanwhile, unlike the exhaust gas derived from the mobile emission source containing NO_{X} that exceeds an environmental regulation range, the exhaust gas derived from the stationary emission source according to an embodiment of the present disclosure may be exhaust gas that contains NO_{X} within the environmental regulation range. Thus, in the case of the exhaust gas derived from the stationary emission source, a treatment process may be concentrated only on nitrogen dioxide (NO₂) among NO_{X}, in which the NO₂ is the main cause of generating a yellow plume that is a visible fume.

Nitrogen dioxide in the exhaust gas may generate visible fumes when the nitrogen dioxide is discharged into the atmosphere. Since the generation of the visible fume depends on a concentration of nitrogen dioxide in a gas, it is generally known that visible fumes occur when 15 ppmv or more of NO₂ is contained in exhaust gas. Thus, according to an embodiment of the present disclosure, a content of NO₂ in the exhaust gas may be 15 ppm or more. For example, the content of NO₂ in the exhaust gas may be 15 ppm or more, 20 ppm or more, 25 ppm or more, 30 ppm or more, 35 ppm or more, 40 ppm or more, 45 ppm or more, 50 ppm or more, 55 ppm or more, or 60 ppm or more. According to another embodiment of the present disclosure, a content of NO₂ in the exhaust gas may be about 15 ppmv to about 70 ppmv.

In the present disclosure, the exhaust gas may include both nitrogen dioxide and nitric (mono) oxide. In the present disclosure, attention is focused on a reduction of nitrogen dioxide to nitric oxide and/or nitrogen rather than a reduction of nitric oxide to nitrogen, so that the method of the present disclosure may be more effective for exhaust gas that has a relatively high content of nitrogen dioxide among total nitrogen oxides. According to an embodiment of the present disclosure, a NO₂/NOₓ ratio of the exhaust gas may be equal to or more than 0.3.

Here, the exhaust gas may include at least one of CO, H₂, and a hydrocarbon. Each of the CO, H₂, and hydrocarbon may independently function as a reductant in the present disclosure, or may function as a reductant by being mixed with each other. According to an embodiment of the present disclosure, when CO is present in the exhaust gas, the content of CO may be equal to or more than 50 ppm. According to another embodiment of the present disclosure, when H₂ is present in the exhaust gas, the content of H₂ may be equal to or more than 500 ppm. According to still another embodiment of the present disclosure, when a hydrocarbon is present in the exhaust gas, the content of a hydrocarbon may be equal to or more than 30 ppm. When each content of CO, H₂, and hydrocarbon is less than the above-described content, there is a problem in that each component does not effectively function as a reductant in the reduction reaction of nitrogen dioxide. The maximum value of each component is not particularly limited unless the each component exceeds the environmental regulatory value. According to still another embodiment of the present disclosure, a ratio of the total amount of reductant to the total amount of the NO_{X} in the exhaust gas may be at least 1:1.

In the present disclosure, the hydrocarbon refers to a compound including carbon and hydrogen. In the present disclosure, the hydrocarbon is not particularly limited as long as it is derived from a reaction process of the stationary emission source. For example, the hydrocarbon may include i-paraffins, n-paraffins, aromatic hydrocarbons, olefins, or alcohols. In view of reactivity with NO₂ in the exhaust gas, the hydrocarbon may include olefins or alcohols. In the olefin production process such as the PDH process, the exhaust gas may contain olefins as the hydrocarbon in the exhaust gas. More specifically, very little amount of propylene is contained in the exhaust gas that is generated during a catalyst regeneration in the PDH process, so that the hydrocarbon may be used as the reductant in the process of the present disclosure.

The method of the present disclosure includes reducing NO₂ in exhaust gas by contacting the exhaust gas with a catalyst. The reducing of NO₂ in exhaust gas by contacting the exhaust gas with a catalyst may be performed in a reactor, in which the catalyst may be fixed in the reactor. According to an embodiment of the present disclosure, the reactor may be any one of the existing facilities of the stationary emission source, and is not particularly limited as long as it is capable of allowing the exhaust gas to be introduced and discharged therethrough and is capable of allowing the catalyst to be installed inside thereof. According to another embodiment of the present disclosure, the reactor may be independently added between the existing facilities of the stationary emission source, the reactor as a reactor for only reducing NO₂ and NO_{X}.

The reducing of NO₂ of the present disclosure is effective in a specific temperature range as described later, and the reducing of NO₂ of the present disclosure is capable of excluding a separate heat exchanging apparatus, so that it may be preferable to install the reactor at a position where a temperature of exhaust gas corresponds to the specific temperature range. For example, in the PDH process, the reactor may be a waste heat boiler (WHB) in which exhaust gas in the temperature range of about 370° C. to about 410° C. is introduced. In other words, by installing the catalyst of the present disclosure in the WHB, the WHB may function as the reactor of the present disclosure.

The reducing of NO₂ of the present disclosure further includes supplying exhaust gas in the reactor. As above-described, when a reacting temperature is determined depending on exhaust gas, the temperature of exhaust gas supplied in the reactor may be a range of about 350° C. to about 500, preferably about 360° C. to about 450, and more preferably 370° C. to 410° C. By installing the reactor at a position where exhaust gas that satisfies the above-described temperature flows in the stationary emission source, there is no need for a separate heat exchanging apparatus, so that it is advantageous in that it is capable of reducing an installation cost not only when initially designing a stationary emission source, but also when adding an SCR facility of the present disclosure to a stationary emission source that is already installed.

In the supplying of exhaust gas of in the reactor of the present disclosure, the exhaust gas may be supplied at a space velocity (SV) of about 20,000 h⁻¹ to about 90,000 h⁻¹. Preferably, the exhaust gas may be supplied at a space velocity of about 30,000 h⁻¹ to 79,000 h⁻¹. More preferably, the exhaust gas may be supplied at a space velocity of about 30,000 h⁻¹ or more to less than 79,000 h⁻¹. When a space velocity is less than that of the above-described range, a required amount of a catalyst for a reduction reaction increases, so that a space to install the catalyst, that is, the size of the reactor, increases. Therefore, there is a problem of increasing cost due to the increasing size of the reactor and the increasing amount of the catalyst being used. There is also a problem in that a reduction rate of nitrogen dioxide according to the amount of the catalyst is poorly effective, which is so-called a poor cost-effectiveness. On the other hand, when a space velocity exceeds that of the above-described range, the amount of exhaust gas that needs to be treated per catalyst is too much, so that there is a problem of decreased reduction rate of nitrogen dioxide.

Again, in the present disclosure, the catalyst may be fixed in the reactor as above-described. In the present disclosure, the catalyst is not particularly limited as long as it is an SCR catalyst that is capable of promoting a reaction between the composition in the exhaust gas of the present disclosure. In other words, the catalyst may be an SCR catalyst that is capable of promoting a reduction reaction of nitrogen dioxide in the exhaust gas by using at least one of CO, H₂, and a hydrocarbon in the exhaust gas.

For example, the catalyst may be an ion-exchanged zeolite catalyst, a noble metal catalyst, or a transition metal catalyst. In the noble metal catalyst, the noble metal may be palladium, platinum, rhodium, ruthenium, iridium, osmium, etc. The ion-exchanged zeolite catalyst has an advantage of having a high activity at a relatively wide operating temperature window, but there is a problem in that the catalyst is easily deactivated due to low hydrothermal stability. In addition, the noble metal catalyst has an advantage of having a high activity at a low temperature range such as the temperature of about 250° C. or less, but it has the activity at a narrow operating temperature window, and there is a problem in that the catalyst has a modest selectivity in reducing nitrogen dioxide.

On the other hand, the transition metal catalyst has advantages in that it has excellent hydrothermal stability and has appropriate durability relative to sulfur and moisture. In addition, the transition metal catalyst is capable of variously adjusting a deNO_{X} performance depending on a metal loading, a calcination temperature, a method of manufacturing, and so on, so that the transition metal catalyst is capable of having a high activity at a wide operating temperature window, and is also capable of having more excellent nitrogen dioxide selectivity than that of the noble metal catalyst. According to an embodiment of the present disclosure, the transition metal catalyst may include Cr, Mn, Fe, Co, Ce, Ni, Cu, Zn, Ga, Mo, Ag, In, Sn, Re, or a combination thereof. Preferably, the transition metal catalyst may include Ag, Co, Cu, or a combination thereof. More preferably, the transition metal catalyst of the present disclosure may include Ag.

According to an embodiment of the present disclosure, the catalyst may be supported by a carrier. The carrier is not particularly limited as long as it functions to support the catalyst and also does not inhibit the performance of the catalyst of the present disclosure. For example, in the present disclosure, Al₂O₃ or TiO₂ may be used as the carrier. Preferably, in the present disclosure, the carrier may be Al₂O₃.

According to an embodiment of the present disclosure, the catalyst includes a transition metal, and the transition metal may be included in an amount of 1 wt % to 5 wt % based on the total weight of the catalyst. When the content of the transition metal is less than 1 wt %, there may be a problem in that the content is too low to function as a catalyst, and when the content of the transition metal exceeds 5 wt %, there may be a problem in that a cost compared to the performance of the catalyst excessively increases due to too many amounts of the transition metal that is carried in the carrier.

According to another embodiment of the present disclosure, when the reducing is performed while the exhaust gas is within a temperature range of about 370° C. to about 410° C., the catalyst may include Ag, and the Ag may be included about 2 wt % to about 3 wt % based on the total weight of the catalyst. More preferably, the Ag may be included about 2.5 wt % to about 3 wt %, even more preferably about more than 2.5 wt % to about 3 wt %, and the most preferably about 3 wt %. A catalyst containing Ag less than the above-described range has poor functionality as a catalyst, and a catalyst containing Ag more than the above-described range has a problem in that a tendency to oxidize the reductant of the present disclosure is greater than that of reducing nitrogen dioxide in the temperature range of the exhaust gas. In addition, in the preferable content range of Ag, there is almost no difference of the NO_{X} reduction rate between when the content of Ag is 2.5 wt % or less and when the content of Ag exceeds 2.5 wt %, but the NO₂ reduction rate is more effective when the content of Ag exceeds 2.5 wt %, so that the content of Ag exceeding 2.5 wt % is preferable to the catalyst of the present disclosure.

The method of the present disclosure includes discharging exhaust gas having passed to through the reducing the nitrogen dioxide in the exhaust gas to the atmosphere. The exhaust gas is discharged into the atmosphere via a chimney. At this time, the content of nitrogen dioxide in the discharged exhaust gas may be less than 15 ppm, preferably 12 ppm or less, more preferably 10 ppm or less, and even more preferably 9 ppm or less. By reducing the content of nitrogen dioxide in the exhaust gas to the value described above, realizing a purpose of the present disclosure of preventing generation of a yellow plume is possible.

According to an embodiment of the present disclosure, the reduced content of nitrogen dioxide in the exhaust gas at the discharging of the exhaust gas may be about 75% or more, about 85% or more, preferably 86% or more, more preferably 90% or more, with respect to the content of the nitrogen dioxide in the initial exhaust gas provided in the method of the present disclosure.

Hereinafter, a better understanding of the present disclosure will be given through the following examples, which are merely set forth to illustrate the present disclosure but are not to be construed as limiting the scope of the present disclosure.

### Example

1. LAB test

On a LAB scale, conversion rates of NO_{X} and NO₂ in exhaust gas were tested by varying conditions as described later. A Ag/Al₂O₃ was used as a catalyst, exhaust gas was introduced in a reactor at a space velocity of 60,000 h⁻¹, and each content of O₂, NO₂, and NO in a front stage of the reactor was adjusted to about 17.9 mol %, 75 ppm, and 11 ppm, respectively.

(1) Comparison of Conversion Rate According to an Impregnation Amount of Ag

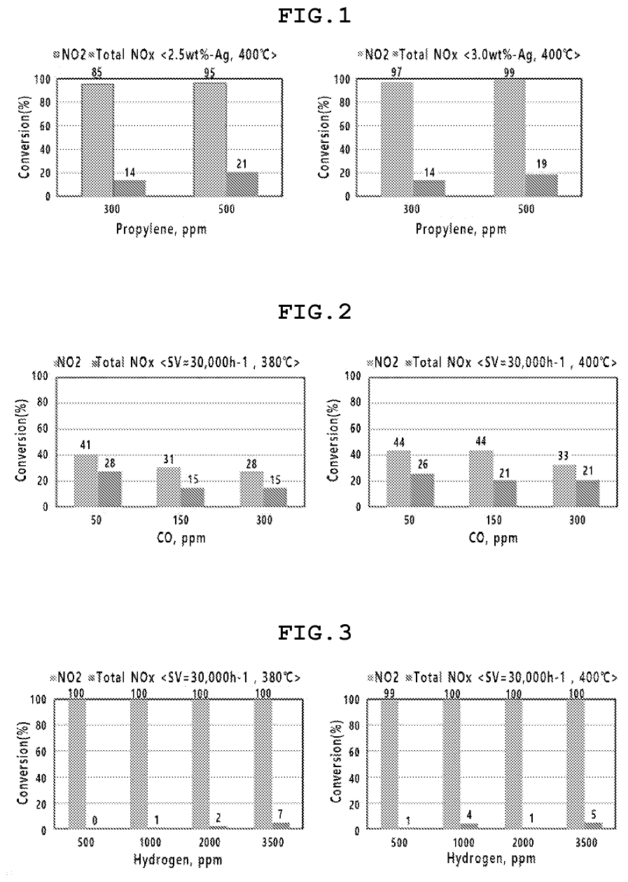

By varying the amount of Ag impregnated in the catalyst to 2.5 wt % and 3.0 wt %, installed in the reactor, and then the conversion rates of NO_{X} and NO₂ were tested. In addition, the test was performed by varying the concentration of propylene as a reductant in the exhaust gas to 300 ppm and 500 ppm. The results of the test were illustrated in FIG. 1.

Referring to FIG. 1, it can be seen that conversion rates of NO₂ were higher when the impregnation amount of Ag was 3.0 wt %, but it can be seen that there was little difference in conversion rates of NO_{X}. Meanwhile, formation of N₂O by a side reaction was not observed.

(2) Comparison of Conversion Rate According to a Type and a Concentration of a Reductant

Conversion rates when each of CO, H₂, and a hydrocarbon present in the exhaust gas functions as the only reductant in the exhaust gas were tested.

1) Reductant: CO Alone

Conversion rates were tested by varying the concentration of CO that is a reductant in the exhaust gas to 50 ppm, 150 ppm, and 300 ppm, and by varying a temperature of the exhaust gas to 380° C. and 400° C. A space velocity was set to 30,000 h⁻¹, and H₂ and the hydrocarbon were not included in the exhaust gas. The results of the test were illustrated in FIG. 2.

2) Reductant: H₂ Alone

The test was performed by including H₂ as a reductant instead of CO. The same procedure as in the 1) Reductant: Co alone was performed, except that the concentration of H₂ was varied at 500 ppm, 1000 ppm, 2000 ppm, and 3500 ppm. The results of the test were illustrated in FIG. 3.

3) Reductant: Propylene Alone

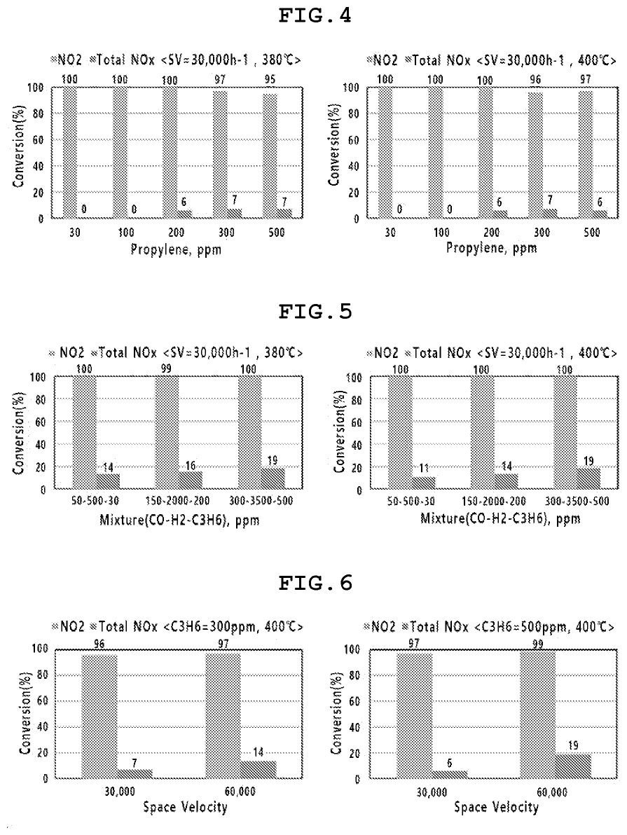

The test was performed by including propylene as a reductant instead of CO. The same procedure as in the 1) Reductant: CO alone was performed, except that the concentration of propylene was varied at 30 ppm, 100 ppm, 200 ppm, 300 ppm, and 500 ppm. The results of the test were illustrated in FIG. 4.

4) Reductant: CO—H₂—C₃H₆ Mix

The test was performed by including CO, H₂, and propylene as a reductant. The same procedure as in the 1) Reductant: CO alone was performed, except that the concentration of CO-H₂—C₃H₆ was varied at 50-500-30 ppm, 150-2000-200 ppm, and 300-3500-500 ppm. The results of the test were illustrated in FIG. 5.

(3) Comparison of Conversion Rate According to a Space Velocity of Exhaust Gas.

1) Reductant: Propylene Alone

The same procedure as in the (2)-3) Reductant: propylene alone in which the concentration of propylene was varied to 300 ppm and 500 ppm was performed, except that the space velocity was varied to 60,000 h⁻¹. The result when the space velocity was 60,000 h⁻¹ and the result when the space velocity was 30,000 h⁻¹ were compared, and the compared results were illustrated in FIG. 6.

2) Reductant: CO, Hydrogen, Propylene Mix

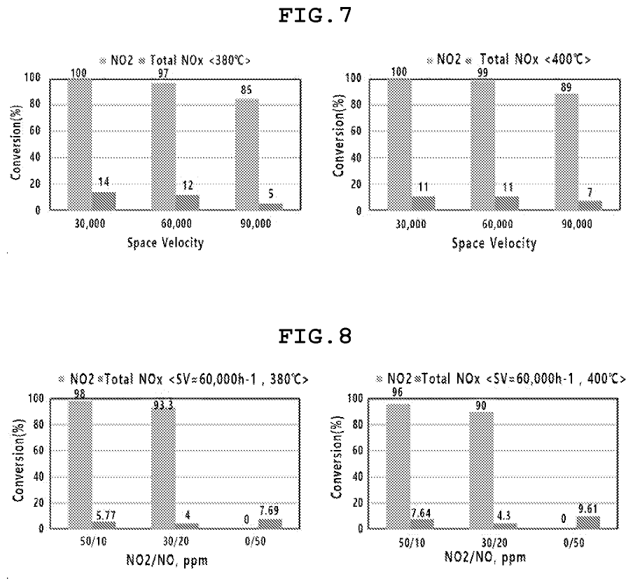

The same procedure as in the (2)-4) Reductant: CO—H₂—C₃H₆ mix in which the concentration of CO—H₂—C₃H₆ was 50-500-30 ppm was performed, except that the space velocity was varied to 60,000 h⁻¹ and 90,000 h⁻¹. The comparison results when each of the space velocity was 30,000 h⁻¹, 60,000 h⁻¹, and 90,000 h⁻¹ were illustrated in FIG. 7.

(4) Comparison of Conversion Rate According to a NO₂/NO_{X} Difference.

The concentration of NO₂/NO_{X} in the exhaust gas was varied to 50/0 ppm, 30/20 ppm, and 0/50 ppm. As a reductant, 200 ppm of hydrogen was included in the exhaust gas. The test was performed by varying the temperature of the exhaust gas to 380° C. and 400° C., and the space velocity was set to 60,000 h⁻¹. The results of the test were illustrated in FIG. 8.

2. Pilot Test

Based on the Lab test results above-described, the pilot test was performed by expanding a scale to a field scale. A waste heat boiler (WHB) in the PDH process has been adopted as a catalytic reactor, and a Ag/Al₂O₃ catalyst in which about 3 wt % of Ag was carried is installed in the reactor. The test was performed under more severe conditions (lower temperature, higher space velocity) than conditions typically applied to an NH₃-SCR. The specific conditions of the test are shown in Table 1 as follows.

TABLE 1

| | | Test Condition | | |
|---|---|---|---|---|
| | | Min | Max | Note |
| Exhaust gas | Nm³/h | 327 | 633 | |
| Flow rate | m³/h | 806 | 1,560 | |
| | (400° C.) | | | |
| Temperature | ° C. | 370 | 410 | |
| Catalyst volume | m³ | 0.008 | | Pilot catalyst |
| | | | | (200 mm*200 mm*50 mm)*4Pc |
| Space velocity | h⁻¹ | 40,900 | 79,188 | Based on 110% load |
| | (Normal) | | | 1.5 to 2.9 times ↑ compared to |
| | | | | NH₃-SCR |
| Linear speed | m/sec | 2.3 | 4.4 | |

The flow rate of the exhaust gas supplied to the reactor was controlled by a branch pipe butterfly valve connected to a front pipe of the WHB, and the temperature in the reactor was stabilized by using an electric heater.

(1) Tendency of Measurement Data

By using an analyzer (NOVA 9K, manufactured by DAEHYUN ENVIRONMENT Corporation), concentrations of reductants, NO₂ and NO_{X} at each front stage and rear stage of the reactor were measured.

1) Tendency in the Front Stage of the Reactor

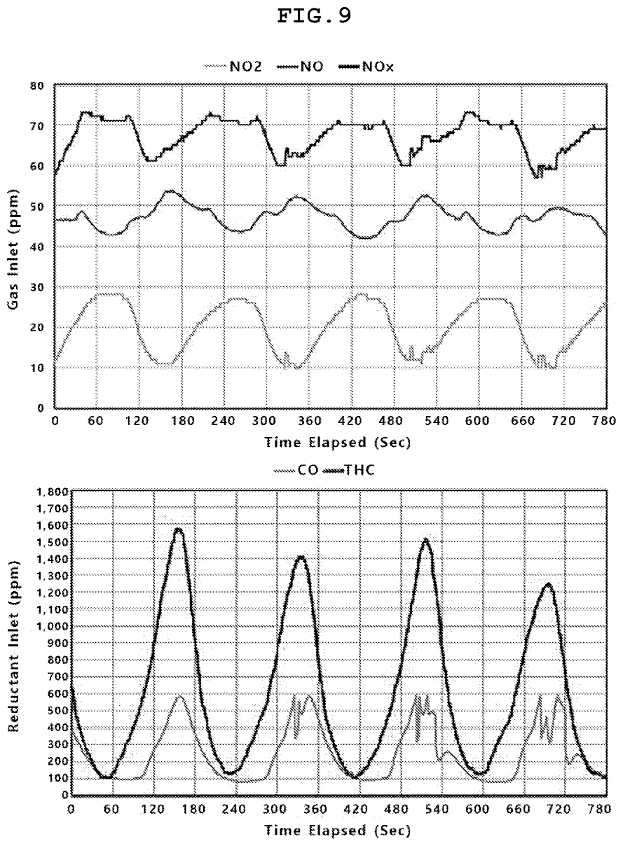

In the front stage of the reactor, the space velocity was controlled by 79,000 h⁻¹, and the temperature was measured to 384° C. At this time, the tendency in the front stage of the reactor measured by the analyzer was illustrated in FIG. 9. Referring to FIG. 9, it can be seen that the concentration difference of each component in the exhaust gas has a periodicity of about three minutes.

2) Tendency in the Rear Stage of the Reactor

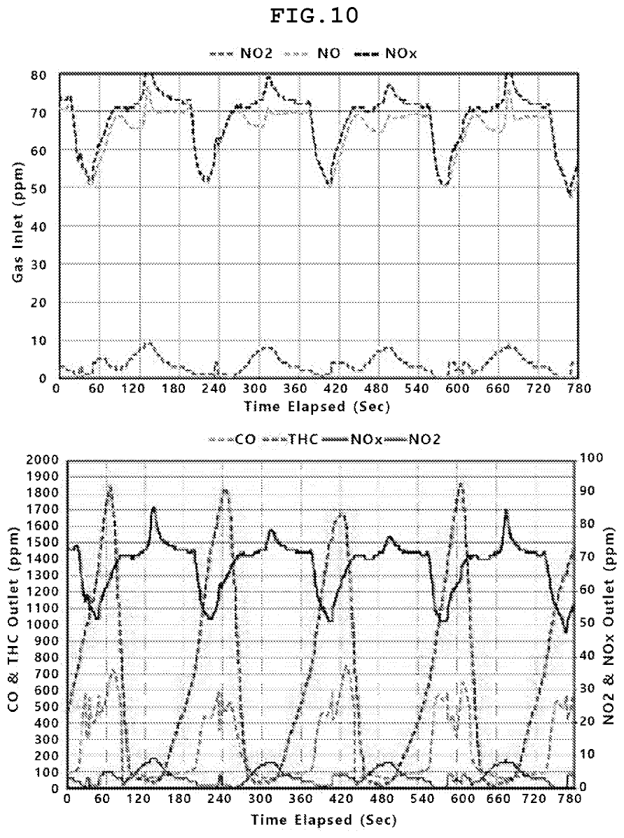

The tendency in the rear stage of the reactor controlled by the same space velocity and the same temperature was analyzed in the same manner as in the front stage of the reactor. The results were illustrated in FIG. 10. Referring to FIG. 10, the concentration difference of each component in the exhaust gas has a periodicity of about three minutes that is the same as in the front stage of the reactor.

(2) Reduction Rate of NO_{X} and NO₂

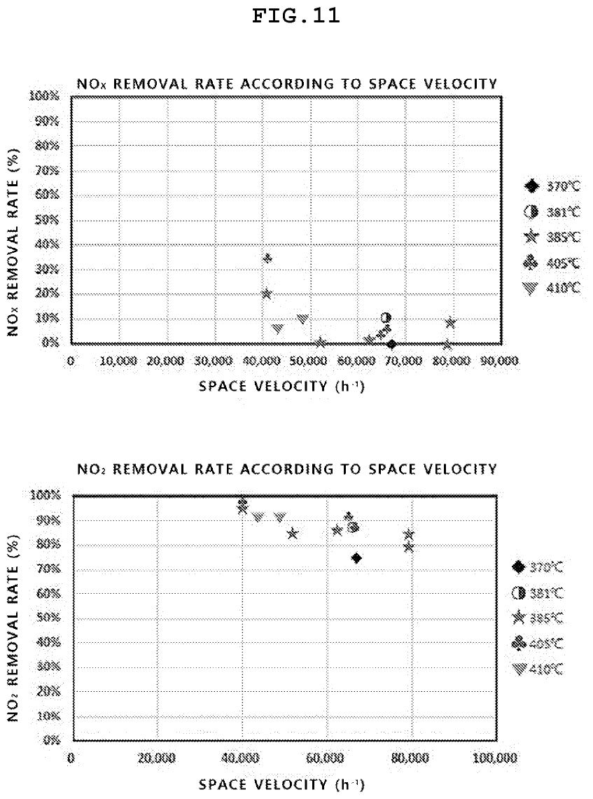

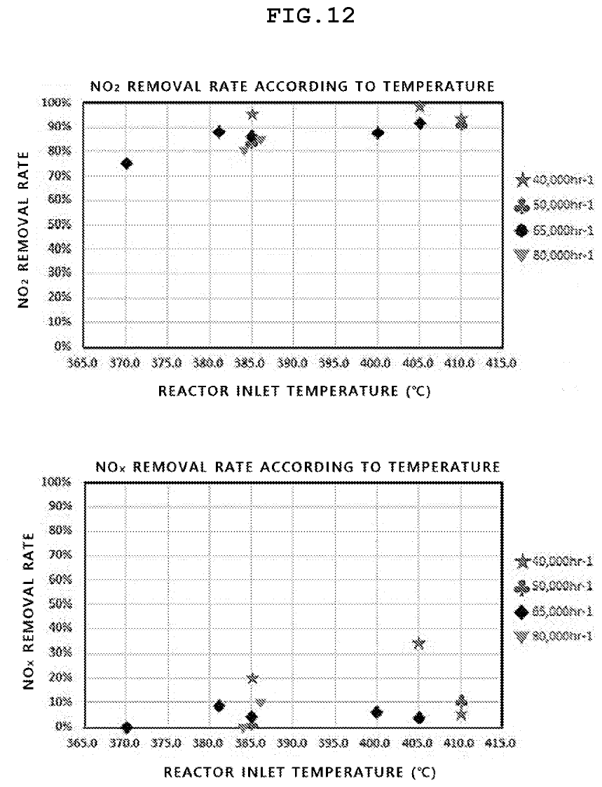

Based on measured data, the conversion rates of NO₂ and NO_{X} according to the space velocity and the conversion rates of NO₂ and NO_{X} according to the temperature were calculated, respectively. The results were illustrated in FIGS. 11 and 12, respectively.

1) Reduction Rate of NO₂ and NO_{X} According to a Space Velocity

Referring to FIG. 11, the maximum reduction rate was realized when the space velocity was the lowest (about 40,900 h⁻¹). At this time, the reduction rate of NO_{X} was about 35% (70 ppm→45 ppm), and the reduction rate of NO₂ was about 99% (25 ppm→0.3 ppm). Meanwhile, when the space velocity was controlled at about 66,000 h⁻¹ or more, it can be seen that the average removal rate of NO₂ is capable of realizing 75% or more (26 ppm→6 ppm).

2) Reduction Rate of NO₂ and NO_{X} According to a Temperature

Referring to FIG. 12, it can be seen that the reduction rate of NO₂ increases as the supply temperature of the exhaust gas increases. In addition, even in a low temperature environment of 370° C. that is a temperature lower than a temperature range of 395° C. to 420° C. which is an actual operating temperature, it is capable of realizing the reduction rate of NO₂ to about 75% (25.8 ppm→6.4 ppm), so that it can be believed to be capable of removing the yellow plume.

(3) Comparison of the Lab Test Results and the Pilot Test Results

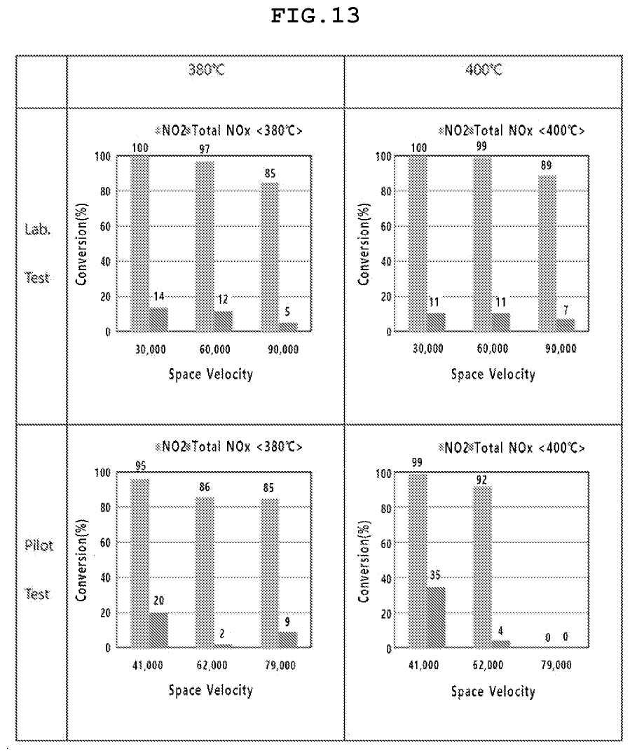

The comparison results of both Lab test and Pilot test were illustrated in FIG. 13. Referring to FIG. 13, it can be seen that the same tendency that the reduction rate of NO₂ increases as the space velocity decreases and as the reaction temperature increases.

While one or more embodiments have been described with reference to the figures, the descriptions of the above-described embodiments are merely examples, and it will be understood by one of ordinary skill in the art that various changes and equivalents thereof may be made. Therefore, the scope of the present disclosure should be defined by the appended claims, and all differences within the scope equivalent to those described in the claims will be construed as being included in the scope of protection defined by the claims.

1. A method of reducing nitrogen dioxide in exhaust gas from a stationary emission source without injecting a reductant while using a selective catalytic reduction (SCR) process, the method comprising:
(a) providing exhaust gas generated from a stationary emission source, wherein the exhaust gas comprises at least one of CO, H₂, and a hydrocarbon;
(b) reducing nitrogen dioxide in the exhaust gas by contacting the exhaust gas with a catalyst; and
(c) discharging the exhaust gas having passed through the reducing the nitrogen dioxide in the exhaust gas to the atmosphere.

2. The method of claim 1, wherein a NO₂/NOₓ ratio in the exhaust gas is equal to or more than 0.3.

3. The method of claim 1, wherein the hydrocarbon comprises i-paraffins, n-paraffins, aromatic hydrocarbons, olefins, or alcohols.

4. The method of claim 1, wherein when CO, H₂, or a hydrocarbon is present in the exhaust gas,
the CO has a content of 50 ppm or more,
the H₂ has a content of 500 ppm or more, or
the hydrocarbon has a content of 30 ppm or more.

5. The method of claim 1, wherein the (b) is performed in a reactor, wherein the catalyst is fixed in the reactor, and
wherein the reducing the nitrogen dioxide in the exhaust gas further comprises (d) supplying the exhaust gas in the reactor, wherein a temperature range of the exhaust gas is 300° C. to 500° C., and
the exhaust gas is supplied to the reactor at a space velocity of 20,000 h⁻¹ to 40,000 h⁻¹.

6. The method of claim 1, wherein the catalyst comprises a transition metal.

7. The method of claim 1, wherein a content of nitrogen dioxide in the exhaust gas discharged at the discharging the exhaust gas is 12 ppm or less.
